(19) United States
(12) Patent Application Publication
(10) Pub. No.: US 2006/0004801 A1
(43) Pub. Date: Jan. 5, 2006

(54) Data consistency in a multi-layer datawarehouse

(76) Inventors: Felix F. Hoefer, Heidelberg (DE); Matthias Lux, Walldorf (DE); Christian Dressler, Walldorf (DE); Peter K. Zimmerer, Walldorf (DE)

Correspondence Address: FISH & RICHARDSON, P.C., PO BOX 1022, MINNEAPOLIS, MN, 55440-1022, US

(21) Appl. No.: 10/838,822

(22) Filed: May 3, 2004

(51) Int. Cl. G06F 17/00

(52) U.S. Cl. 707/101

(57) ABSTRACT

Systems, methods, and computer program products for data consistency in a database management system. A method may be provided that modifies a plurality of data packages stored in different data containers within a database management system. That method may include receiving a request at the database management system to modify a first data package in a first data container, and modifying the first data package and a second data package in a second data container based on common data in the first and second data packages. Modifying the first and second data packages may include deleting and/or invalidating the first and second data packages. Modifying the first and second data packages based on common data may include modifying the first and second data packages based on an association of the first and second data packages that is formed by a delta management system.

### BACKGROUND

The following description relates to data consistency in a database management system.

A database management system can include a computer system and one or more data containers. In a scenario where there are multiple data containers, the database is also known as a datawarehouse. Each data container in a database management system can include one or more database tables. A database table represents classes of physical or conceptual objects, in which each object is represented by a record that may have one or more attributes. For example, if a database were used to keep track of employees in a corporation, each record might represent an employee and include attributes such as a first name, last name, home address, and telephone number. A key field may be used to identify each record. The key field may be an attribute of a record or some other identifier that identifies a record.

The data containers may be of any of type, including an Operational Data Store (ODS)-type, a Persistent Staging Area (PSA)-type, and a data cube. Data in each of the different types of data containers may be organized, formatted, and/or identified differently. Thus, for example, an ODS data container can store data in transparent, flat database tables and fact tables or dimension tables need not be created, whereas a data cube can be a collection of relational tables arranged according to the star schema that includes fact tables and dimension tables, while a PSA data container can store transactional data in relational database tables. The data containers may have overlapping data, such that the same data exists in multiple data containers. Thus, for example, data may be identified as data packages A and B of a data cube, while the same data may be identified as a single data package C in an ODS data container.

In order to keep data consistent among various data containers, particularly when transferring data from one data container to another, data may be synchronized using various rules, transformations, and filters. Also, different techniques may be used to modify data in the various data containers.

### SUMMARY

Systems, methods, and computer program products for data consistency in a database management system.

In one general aspect, a method is provided that modifies a plurality of data packages stored in different data containers within a database management system. That method includes receiving a request at the database management system to modify a first data package in a first data container, and modifying the first data package and a second data package in a second data container based on common data in the first and second data packages.

Implementations may include one or more of the following features. Modifying the first and second data packages may include deleting and/or invalidating the first and second data packages. The method may further include modifying an Nth data package in an Nth data container based on common data in the Nth data package and an (N−1)th data package in an (N−1)th data container. For example, if a third data container exists, a third data package in the third data container may be modified based on common data in the third data package and the second data package. Modifying the Nth data package based on common data in the Nth and (N−1)th data packages may include modifying the Nth data package based on an association of the Nth and (N−1)th data packages. In that case, the method further includes forming at a delta management system the association of the Nth and (N−1)th data packages based on common data in the Nth and (N−1)th data packages.

Modifying the first and second data packages based on common data may include modifying the first and second data packages based on an association of the first and second data packages. In that case, the method further includes forming at a delta management system the association of the first and second data packages based on common data in the first and second data packages. Modifying the first and second data packages may include modifying the first and second data packages substantially in parallel. Modifying the first and second data packages may include modifying the first and second data packages at substantially the same time. Modifying the first and second data packages may include modifying the first data package prior to modifying the second data package.

In another aspect, a database management system includes data containers and a computer system in communication with the data containers. In that case, the data containers include at least a first data container and a second data container and the computer system is configured to perform operations that include receiving a request at the database management system to modify a first data package in the first data container, and modifying the first data package and a second data package in the second data container based on common data in the first and second data packages.

Implementations may include one or more of the following features. The operation of modifying the first and second data packages may include deleting and/or invalidating the first and second data packages. The computer system may be further configured to perform operations that include modifying an Nth data package in an Nth data container based on common data in the Nth data package and an (N−1)th data package in an (N−1)th data container. Modifying the Nth data package based on common data in the Nth and (N−1)th data packages may include modifying the Nth data package based on an association of the Nth and (N−1)th data packages. In that case, the computer system may be further configured to perform operations that include forming at a delta management system the association of the Nth and (N−1)th data packages based on common data in the Nth and (N−1)th data packages.

Modifying the first and second data packages based on common data may include modifying the first and second data packages based on an association of the first and second data packages. In that case, the computer system may be further configured to perform operations that include forming at a delta management system the association of the first and second data packages based on common data in the first and second data packages. The operation of modifying the first and second data packages may include modifying the first and second data packages substantially in parallel. The operation of modifying the first and second data packages may include modifying the first and second data packages at substantially the same time. The operation of modifying the first and second data packages may include modifying the first data package prior to modifying the second data package.

In another aspect, a computer program product, tangibly embodied on an information carrier, includes instructions that are operable to cause a data processing apparatus to receive a request at a database management system to modify a first data package in a first data container, and modify the first data package and a second data package in a second data container based on common data in the first and second data packages.

Implementations may include one or more of the following features. The instructions operable to cause a data processing apparatus to modify the first and second data packages may include instructions to delete and/or invalidate the first and second data packages. The instructions operable to cause a data processing apparatus to modify the first and second data packages based on common data may include instructions to modify the first and second data packages based on an association of the first and second data packages. That association may be formed at a delta management system and may be based on common data in the first and second data packages. The computer program product may further include instructions operable to cause a data processing apparatus to modify an Nth data package in an Nth data container based on common data in the Nth data package and an (N−1)th data package in an (N−1)th data container. The instructions operable to cause data processing apparatus to modify the Nth data package based on common data in the Nth and (N−1)th data packages may include instructions to modify the Nth data package based on an association of the Nth and (N−1)th data packages. That association may be formed at a delta management system and the association may be based on common data in the Nth and (N−1)th data packages.

The database management system and related techniques described here may provide one or more of the following advantages. A database management system may include multiple data containers that have common data. Data may be kept consistent among the multiple data containers by consistently modifying common data that exists across the data containers. The data may be consistently invalidated and/or deleted. The process may involve the use of a list of associations that tracks common data in the multiple data containers. The list may be generated by a delta management system, which may advantageously reduce overhead in keeping the data consistent because the associations need not be independently generated. Also, because the associations may be generated by a portion of the database management system that is already aware of the data that is common, the task of determining data packages that have common data may be facilitated. The consistent modification of data may be performed as a single logical unit of work that either fails or succeeds entirely, which may advantageously ensure that the data across the data containers is kept in a consistent state. In addition, the techniques may be applied to a database management system with multiple layers of data containers, which may ensure data consistency across a potentially vast data landscape.

Details of one or more implementations are set forth in the accompanying drawings and the description below. Other features and advantages may be apparent from the description and drawings, and from the claims.

### BRIEF DESCRIPTION OF THE DRAWINGS

These and other aspects will now be described in detail with reference to the following drawings.

FIG. 1 is a diagram of a database management system with two data containers and a delta management system.

FIG. 2 is a diagram of a database management system with multiple layers of data containers and multiple delta management systems.

FIG. 3 is a flowchart of a method of providing data consistency in a database management system.

### DETAILED DESCRIPTION

The systems and techniques described here relate to data consistency in a database management system.

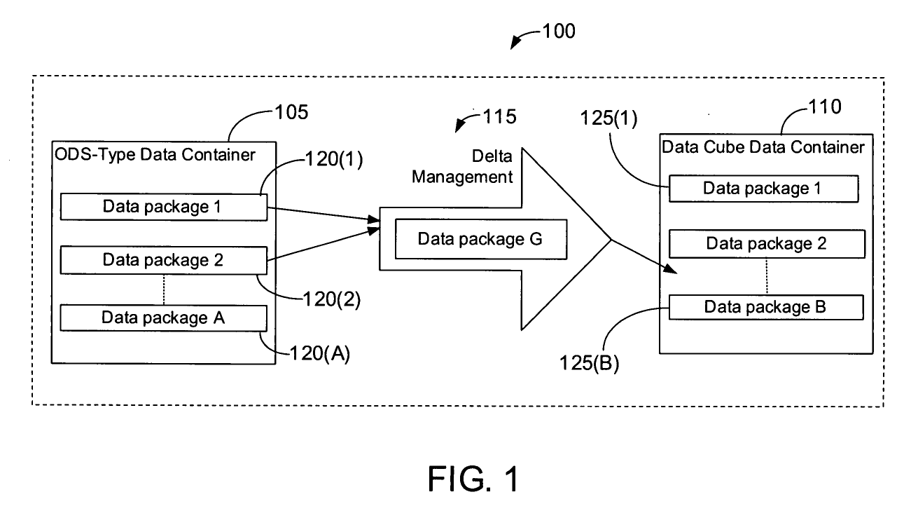

FIG. 1 is a diagram of a database management system 100 with an ODS data container 105, a data cube 10 data container, and a delta management system 115. FIG. 1 illustrates the relationships among data packages throughout the database management system 100. Data packages 120 are identified as data package 1 (120(1)) through data package A (120(A)) within a database table of the ODS data container 105. Data packages 125 are identified as data package 1 (125(1)) through data package B (125(B)) within a database table of the data cube 110.

In FIG. 1, the ODS data container 105 and the data cube 110 have common data, which is kept consistent, in part, by the delta management system 115. One way the delta management system 115 keeps data consistent is by updating data, which may involve changing values of data that already exist or adding new data. When updates are made to the ODS data container 105 (i.e. a source data container), a process is started which causes the delta management system 115 to have a delta data package. The delta data package in the delta management system 115 can represent one or more changes to one or more data packages in the ODS data container 105. Thus, there is typically an N to 1 relationship between data packages in the source and the data package in the target. The delta data package can include one or more data sets to represent those changes. In addition, the delta data package handled by the delta management system 115 may be identified by a different identifier than the identifier used to identify the source data packages in the ODS data container 105. The identifier used by the delta management system 115 may correspond to the data package that will be updated in the data cube 110 (i.e. target data container). For example, the delta management system 115 has a delta data package identified as data package G, which is derived from data packages 1 and 2 (i.e. 120(1) and 120(2)) of the ODS data container 105. The identifier may be a key field that uniquely identifies the data package within a database table in the data cube 110. Thus, following the example, if “G” is a value of a key field, the changes in the delta management system 115 may be identified by the identifier “G” (i.e. the identifier of the data package in the target data container).

The delta management system 115 causes the data cube 110 to be updated with the delta data package handled by the delta management system 115. For example, in FIG. 1, the delta management system 115 may update data package G in the data cube 110 with a delta data package.

The delta management system 115 has a list of data packages (not shown), that tracks updates to the data cube 110 by indicating the data packages that have been used to update the data cube 110. The list associates identifiers for the data packages in the source data container with an identifier of the data package in the target data container. For example, the list may include an association of the data packages 1 and 2 with the data package G. In alternative implementations, techniques other than a list may be used to track data packages with common data.

Data can also be kept consistent in the database management system 100 by consistently invalidating data packages that have common data. In other words, if data is invalidated in the ODS data container 105, the database management system 100 or a component thereof may ensure that all data packages that share that data are also invalidated. Data is consistently invalidated in the database management system 100 with reference to the list of associations formed by the delta management system 115.

Once the database management system 100 determines that a data package in a data container, such as the ODS data container 105, is going to be invalidated, the database management system 100 reviews the list of associations formed by the delta management system 115 to determine which data packages in other containers contain common data and should also be invalidated. For example, if a request is sent to the database management system 100 to invalidate data package 1, the database management system 100 reviews the list of associations and determines that the data package G, which exists in the data cube 110, has common data and should also be invalidated.

The process of determining which data to invalidate can also be known as “targeting” the associated data packages for invalidation. All of the data packages that have common data may be invalidated substantially in parallel. Using the associations formed by the delta management system 115 is advantageous because the database management system 100 need not form the associations independently of other processes that occur in the database management system 115. Also, associations may be more difficult to form after data is updated, thus the effort required to determine the data packages that have common data is generally reduced.

The process of invalidating data may include using a list of data packages that have been “targeted” for invalidation. The invalidation of the data packages may occur substantially in parallel, which may include invalidating the data packages at the same time, or commencing the invalidation of a data package at about the same time another data package is invalidated. Alternatively, data packages may only be invalidated in close temporal proximity to each other. For example, a first data package may be invalidated, and shortly thereafter, a second data package may be invalidated. In any case, the data packages should be invalidated such that invalidating all of the targeted data packages succeeds or fails, so the database management system 100 is not left in an inconsistent state the next time the data is accessed. Invalidating the data packages in such a manner is known as “a single logical unit of work,” and may involve the use of locking resources from being edited and/or preventing processes from running to ensure that the invalidating occurs as a single logical unit of work and to ensure that the data containers are not left in an inconsistent state.

In alternative implementations, the data may be deleted in addition to, or instead of, being invalidated. Also, in alternative implementations associations between data containers in the database management system 100 may be tracked by a mechanism other than the delta management system 115. In addition, the database management system 100 may invalidate and/or delete the data as soon as it is determined that the data should be invalidated and/or deleted. In alternative implementations, the associations of data packages in the data containers need not be formed in response to an update of data by the delta management system 115.

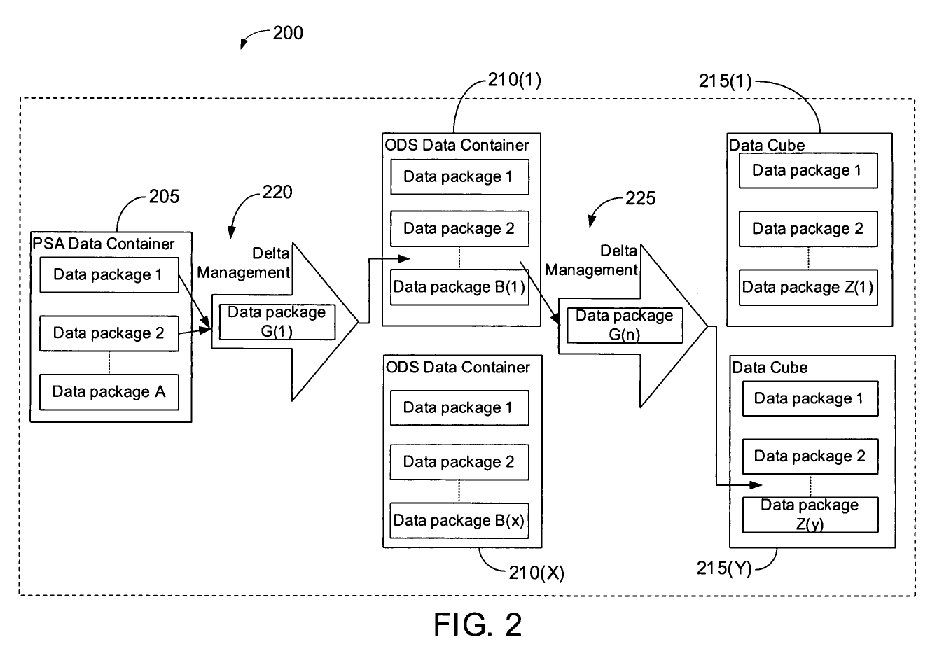

FIG. 2 is a diagram of a database management system 200 with multiple layers of data containers and multiple delta management systems. The layers in the database management system 200 include a first layer with a PSA data container 205, a second layer including ODS data containers 210, and a third layer including data cubes 215. Data packages in each of the data layers may be identified differently.

Consistency among data in the database management system 200 is maintained by a delta management system between each layer of data containers. For example, the database management system 200 may include three layers of data containers, a delta management system 220, and a delta management system 225.

An update of data can occur across any number of layers in the database management system 200. For example, a change may be made to data packages 1 and 2 of the PSA data container 205. In order to reflect this change in the ODS data containers 210, a delta data package can be generated, and that delta data package can be used to update a data package which may be uniquely identified by “G(1),” which may be a value of a key field in a database table in one of the data cubes 215. In response to the change in one or more ODS data containers 210, a delta data package can be generated to update a data package uniquely identified by “G(n)” (i.e. the value of a key field) in a database table in one of the data cubes 215. A data container is only updated if a data package managed by a delta management system changes or adds to data in the data container. Because layers of data containers in the database management system 200 are updated based on changes to other layers (i.e. PSA data container 205 is updated, then ODS data containers 210 are updated, and then data cubes 215 are updated), a “cascading” effect of updating occurs.

Invalidation and/or deletion of data in the database system may be performed such that there is a “cascading” of invalidation and/or deletion. As described in reference to FIG. 1, a delta management system may have a list of associations of data packages across a database management system. Thus, in order to consistently invalidate and/or delete data, in response to a request to invalidate and/delete a data package, the list of associations can be used to target the data packages that have data common to the data in the data package which was requested to be invalidated and/or deleted.

One example technique involves a request that is received, at the database management system 200, to invalidate data package 1 in a database table of the PSA data container 205. In response to the request, the database management system 200 uses the delta management system 220 to determine the data packages that have data common to data package 1. By reviewing the list of associations formed by the delta management system 220, the database management system 200 can determine that data package 1 is associated with data package G(1), which is in one of the ODS data containers 210. The database management system 200 can review the list of associations formed by the delta management system 225 to determine that the data package G(1) is associated with the data package G(n) of a database table in one of the data cubes 215. Once the associated data packages have been determined, the database management system 200 can modify the data packages as a single logical unit of work such that modifications to the data packages with common data either succeed or fail entirely. Alternatively, the database management system 200 may modify the data packages as a single logical unit of work by identifying the associated data packages for each layer and modifying the data packages in one layer before modifying the data packages in another layer. For example, the data package G(1) can be invalidated, then the database management system 200 can identify the data package G(n) as having common data and invalidate data package G(n) in one of the data cubes 215. In any case, the modification of the data packages should either succeed or fail entirely, as a single logical unit of work. Also, the data packages may be modified substantially in parallel.

In alternative implementations, any type of modification, other than or in addition to deletion or invalidation, can be performed on the data packages that include the common data. In alternative implementations the database management system 200 can have any number of layers. Also, each layer can have any number of data containers. Also, in alternative implementations a delta management system need not exist between each layer of data containers, and any number of delta management systems may manage changes in the database management system 200. For example, a delta management system may exist for each data container, or alternatively, a single delta management system may exist for the entire database management system 200. In alternative implementations each layer in the database management system 200 need not have a different type of data container. Also, data packages need not be identified differently in each layer. For example, data packages may be uniquely identified within a data container.

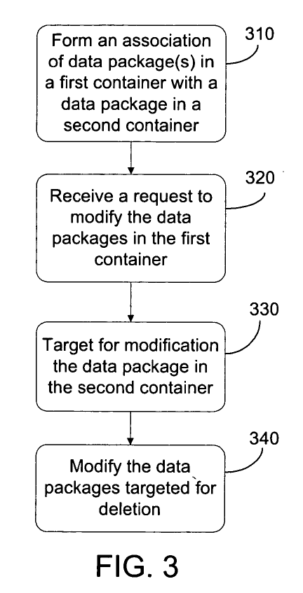

FIG. 3 is a flowchart of a method of providing data consistency in a database management system. The database management system of FIG. 3 has two data containers, a first container and a second container. In alternative implementations, the database management system may have more than two data containers, each of which contains any number of database tables. The data containers may be organized as any of a number of layers in the database management system. In addition, the database management system may include one or more delta management systems that update data across the data containers and associate data packages with common data as part of performing data updates.

At 310 one or more data packages in the first container are associated with a data package in the second container. The association may be in response to an update of data, in the data containers, caused by a delta management system. Alternatively, the association may be in response to any event, and the association may be formed by any mechanism or component of the database management system.

At 320 a request is received to modify a data package in the first data container. The request can be a request to delete, invalidate or otherwise modify a data package in the first data container. The request may be received via a user interface, or from a service of a computer system. As examples, a user may request that a record be deleted or a service in a database management system may periodically delete data that is more than six months old.

At 330 the data package in the second container is targeted for modification, which involves determining that the data package in the second data container has common data with the data package in the first data container that was requested to be modified. The determination can be made by reviewing a list of associations formed by a delta management system. Alternatively, the determination may be made by any component of the database management system.

At 340 the data package in the first container, which was requested to be modified, and the data package in the second container, which contains common data, are modified. The data packages are modified substantially in parallel. In one implementation, the data packages can be modified at the same time. In another implementation, the data packages can be modified one-after-another. In any case, the data packages should be modified as a “single logical unit of work,” such that all data packages having common data to the first data package are successfully modified or are not. By modifying the data packages as a single logical unit of work the data containers in the database management system are not in an inconsistent state for later accesses of data.

Although the method of providing data consistency is shown in FIG. 3 as being composed of four different processes, additional and/or different processes can be used instead. For example, several of the processes may be combined such that data packages are modified based on common data in the data packages. Similarly, the processes need not be performed in the order depicted. Thus, although a few implementations have been described in detail above, other modifications are possible. Other implementations may be within the scope of the following claims.

1. A method of modifying a plurality of data packages stored in different data containers within a database management system, the method comprising:
receiving a request at the database management system to modify a first data package in a first data container; and
modifying the first data package and a second data package in a second data container based on common data in the first and second data packages.

2. A method in accordance with the method of claim 1, wherein modifying the first and second data packages comprises deleting the first and second data packages.

3. A method in accordance with the method of claim 1, wherein modifying the first and second data packages comprises invalidating the first and second data packages.

4. A method in accordance with the method of claim 1, further comprising:
modifying an Nth data package in an Nth data container based on common data in the Nth data package and an (N−1)th data package in an (N−1)th data container.

5. A method in accordance with the method of claim 4, wherein modifying the Nth data package based on common data in the Nth and (N−1)th data packages comprises modifying the Nth data package based on an association of the Nth and (N−1)th data packages, the method further comprising:
forming at a delta management system the association of the Nth and (N−1)th data packages based on common data in the Nth and (N−1)th data packages.

6. A method in accordance with the method of claim 1, wherein modifying the first and second data packages based on common data comprises modifying the first and second data packages based on an association of the first and second data packages, the method further comprising:
forming at a delta management system the association of the first and second data packages based on common data in the first and second data packages.

7. A method in accordance with the method of claim 1, wherein modifying the first and second data packages comprises modifying the first and second data packages substantially in parallel.

8. A method in accordance with the method of claim 1, wherein modifying the first and second data packages comprises modifying the first and second data packages at substantially the same time.

9. A method in accordance with the method of claim 1, wherein modifying the first and second data packages comprises modifying the first data package prior to modifying the second data package.

10. A database management system comprising:
a plurality of data containers comprising at least a first data container and a second data container;
a computer system in communication with the plurality of data containers, the computer system configured to perform operations comprising:
receiving a request at the database management system to modify a first data package in the first data container; and
modifying the first data package and a second data package in the second data container based on common data in the first and second data packages.

11. A database management system in accordance with claim 10, wherein the operation of modifying the first and second data packages comprises deleting the first and second data packages.

12. A database management system in accordance with claim 10, wherein the operation of modifying the first and second data packages comprises invalidating the first and second data packages.

13. A database management system in accordance with claim 10, wherein the computer system is further configured to perform operations comprising:
modifying an Nth data package in an Nth data container based on common data in the Nth data package and an (N−1)th data package in an (N−1)th data container.

14. A database management system in accordance with claim 13, wherein modifying the Nth data package based on common data in the Nth and (N−1)th data packages comprises modifying the Nth data package based on an association of the Nth and (N−1)th data packages and the computer system is further configured to perform operations comprising:
forming at a delta management system the association of the Nth and (N−1)th data packages based on common data in the Nth and (N−1)th data packages.

15. A database management system in accordance with claim 10, wherein modifying the first and second data packages based on common data comprises modifying the first and second data packages based on an association of the first and second data packages, and the computer system is further configured to perform operations comprising:
forming at a delta management system the association of the first and second data packages based on common data in the first and second data packages.

16. A database management system in accordance with claim 10, wherein the operation of modifying the first and second data packages comprises modifying the first and second data packages substantially in parallel.

17. A database management system in accordance with claim 10, wherein the operation of modifying the first and second data packages comprises modifying the first and second data packages at substantially the same time.

18. A database management system in accordance with claim 10, wherein the operation of modifying the first and second data packages comprises modifying the first data package prior to modifying the second data package.

19. A computer program product, tangibly embodied on an information carrier, the computer program product comprising instructions operable to cause data processing apparatus to:
receive a request at a database management system to modify a first data package in a first data container; and
modify the first data package and a second data package in a second data container based on common data in the first and second data packages.

20. A computer program product in accordance with claim 19, wherein the instructions operable to cause data processing apparatus to modify the first and second data packages comprise instructions to delete the first and second data packages.

21. A computer program product in accordance with claim 19, wherein the instructions operable to cause data processing apparatus to modify the first and second data packages comprise instructions to invalidate the first and second data packages.

22. A computer program product in accordance with claim 19, wherein
the instructions operable to cause data processing apparatus to modify the first and second data packages based on common data comprise instructions to modify the first and second data packages based on an association of the first and second data packages;
the association is formed at a delta management system; and
the association is based on common data in the first and second data packages.

23. A computer program product in accordance with claim 19, wherein the computer program product further comprises instructions operable to cause data processing apparatus to:
modify an Nth data package in an Nth data container based on common data in the Nth data package and an (N−1)th data package in an (N−1)th data container.

24. A computer program product in accordance with claim 23, wherein
the instructions operable to cause data processing apparatus to modify the Nth data package based on common data in the Nth and (N−1)th data packages comprise instructions to modify the Nth data package based on an association of the Nth and (N−1)th data packages;
the association is formed at a delta management system; and
the association is based on common data in the Nth and (N−1)th data packages.
